(19) United States
(12) Patent Application Publication
(10) Pub. No.: US 2009/0057480 A1
(43) Pub. Date: Mar. 5, 2009

(54) Helicopter Tail Assembly

(76) Inventor: Charles Lin, Preston, MS (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 11/846,566

(22) Filed: Aug. 29, 2007

(51) Int. Cl. B64C 27/04

(52) U.S. Cl. 244/17.19

(57) ABSTRACT

A helicopter tail assembly includes a tail boom that extends along a tail axis, a tail fin mounted on one end of the tail boom, and a rudder mounted on the tail fin and pivotable relative to the tail fin about a pivot axis that is inclined with respect to the tail axis at an angle greater than 0 degrees and less than 90 degrees.

### BACKGROUND OF THE INVENTION

1. Field of the Invention

The invention relates to a twin-rotor helicopter, more particularly to a helicopter tail assembly for a twin-rotor helicopter.

2. Description of the Related Art

As shown in FIGS. 1 to 3, a conventional twin-rotor helicopter includes a tail boom 1 that extends along a tail axis (X). For yaw control, the twin-rotor helicopter further includes a pair of first rudders 2 mounted on the tail boom 1 and each pivotable about a respective pivot axis parallel to the tail axis (X), a pair of second rudders 3 mounted on the tail boom 1 and each pivotable about a respective pivot axis parallel to a transverse axis (Z) that is transverse to the tail axis (X), a pair of first control links 4 respectively coupled to the first rudders 2, and a pair of second control links 5 respectively coupled to the second rudders 3. Each of the first rudders 2 has a pair of opposite first rudder surfaces 201. Each of the second rudders 3 has a pair of opposite second rudder surfaces 301.

As shown in FIG. 2, when the twin-rotor helicopter flies forward, since the first rudder surfaces 201 of the first rudders 2 are disposed parallel to an air stream 6 that flows rearwards, the air stream 6 is unable to exert forces for yaw control on the first rudders 2. Therefore, yaw control is achieved through operation of the second control links 5 to control pivoting of the second rudders 3 so that the air stream 6 can exert forces on the second rudder surfaces 301 of the second rudders 3. For instance, when the twin-rotor helicopter is to turn right while flying forward, the second rudders 3 are controlled through the second control links 5 to turn right.

On the other hand, as shown in FIG. 3, when the twin-rotor helicopter hovers, since the second rudder surfaces 301 of the second rudders 3 are disposed parallel to an air stream 7 that flows downwards, the air stream 7 is unable to exert forces for yaw control on the second rudders 3. Therefore, yaw control is achieved through operation of the first control links 4 to control pivoting of the first rudders 2 so that the air stream 7 can exert forces on the first rudder surfaces 201 of the first rudders 2. For instance, when the twin-rotor helicopter is to turn left while hovering, the first rudders 2 are controlled through the first control links 4 to turn left.

In the aforementioned twin-rotor helicopter, the second rudders 3 are used for yaw control while the twin-rotor helicopter flies forward, whereas the first rudders 2 are used for yaw control while the twin-rotor helicopter hovers. Since two different types of rudders 2, 3 are installed in the conventional twin-rotor helicopter, manufacturing costs are relatively high, the helicopter weight is increased, and yaw control is relatively difficult to conduct.

### SUMMARY OF THE INVENTION

Therefore, the object of the present invention is to provide a helicopter tail assembly for a twin-rotor helicopter that has a relatively simple construction and that can make yaw control easier to conduct.

According to the present invention, a helicopter tail assembly comprises: a tail boom that extends along a tail axis; a tail fin mounted on one end of the tail boom; and a rudder mounted on the tail fin and pivotable relative to the tail fin about a pivot axis that is inclined with respect to the tail axis at an angle greater than 0 degrees and less than 90 degrees.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic side view of a conventional twin-rotor helicopter;

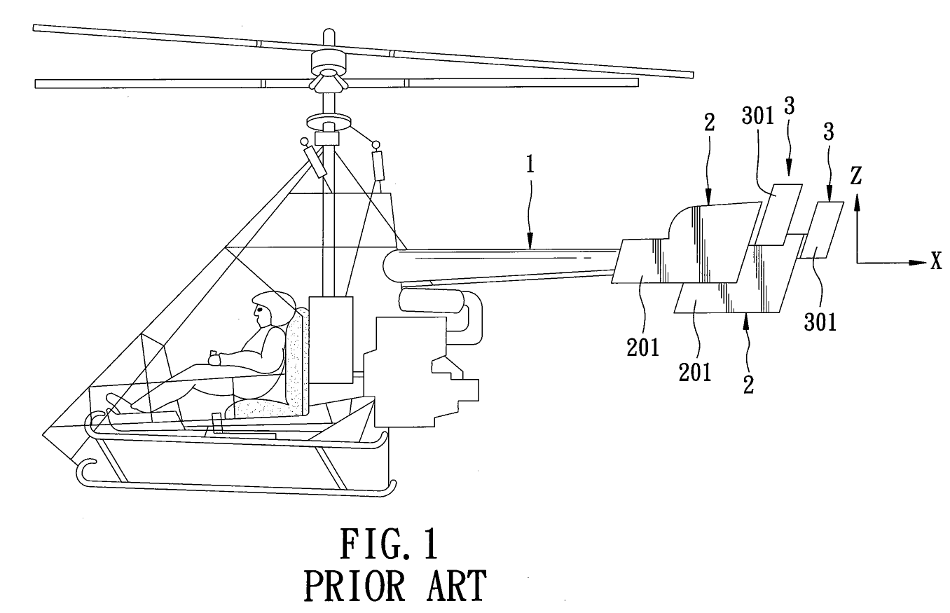

FIG. 2 is a fragmentary schematic top view of the conventional twin-rotor helicopter to illustrate yaw control when the helicopter flies forward;

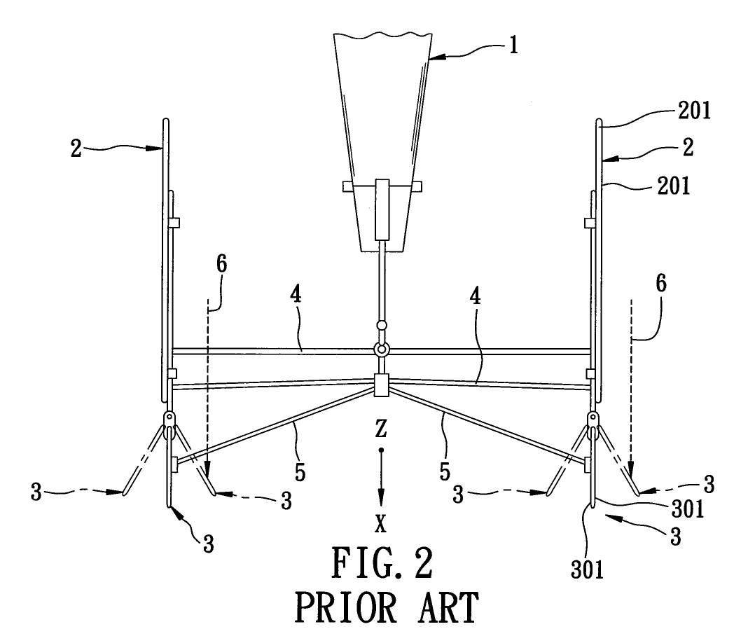

FIG. 3 is a fragmentary schematic rear view of the conventional twin-rotor helicopter to illustrate yaw control when the helicopter hovers;

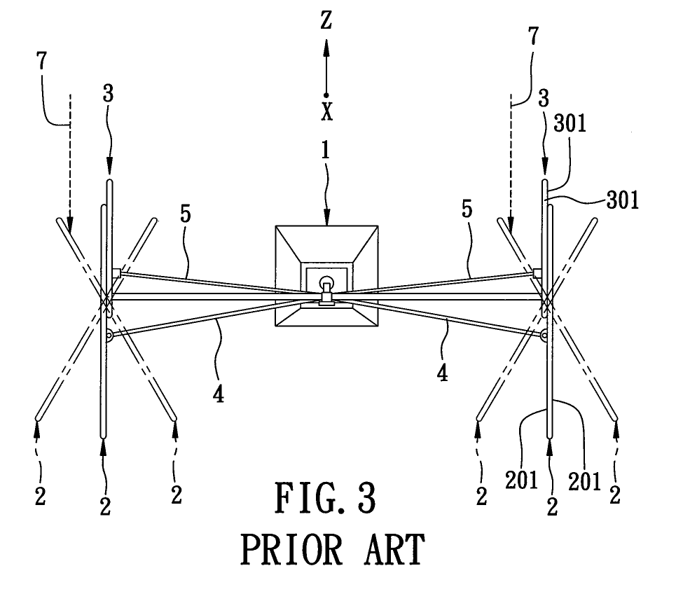

FIG. 4 is a schematic side view of a twin-rotor helicopter that incorporates the preferred embodiment of a helicopter tail assembly according to the present invention;

FIG. 5 is a fragmentary perspective view of the preferred embodiment;

FIG. 6 is a view similar to FIG. 5 for illustrating pivoting movement of a rudder of the preferred embodiment; and

FIG. 7 is a fragmentary schematic top view of the preferred embodiment for illustrating left and right pivoting movement of the rudder.

### DETAILED DESCRIPTION OF THE PREFERRED EMBODIMENT

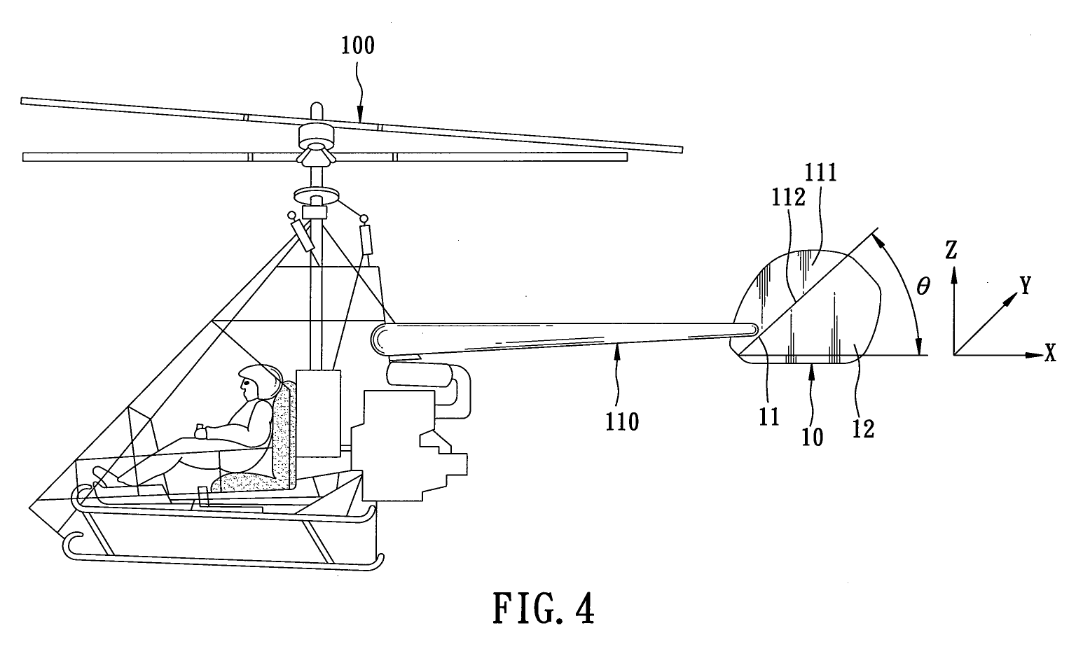

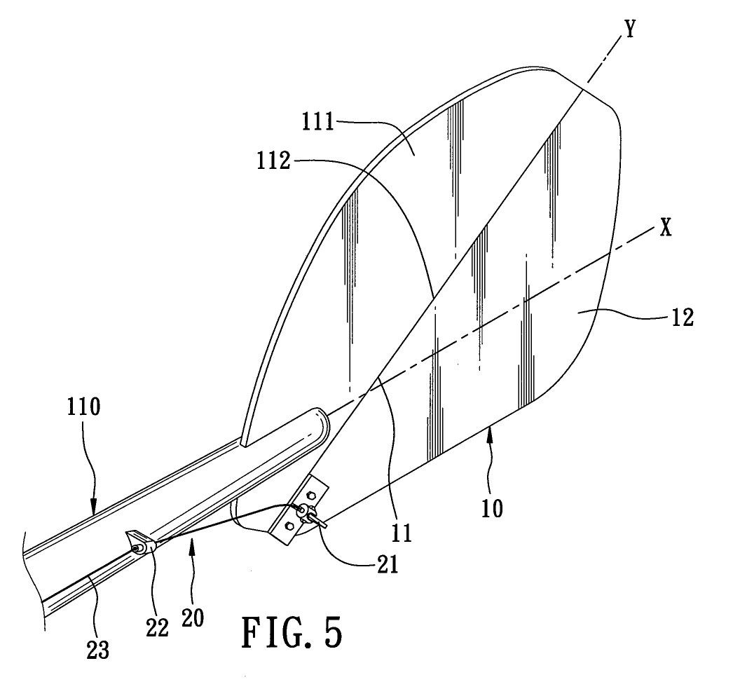

Referring to FIGS. 4 to 6, the preferred embodiment of a helicopter tail assembly for a twin-rotor helicopter 100 according to the present invention is shown to comprise a tail boom 110, a tail fin 111, a rudder 10, and an operating unit 20.

The tail boom 110 extends along a horizontal tail axis (X). The tail fin 111 is mounted on one end of the tail boom 110. The rudder 10 is mounted on the tail fin 111 and is pivotable relative to the tail fin 111 about a pivot axis (Y) that is inclined with respect to the tail axis (X) at an angle (θ) greater than 0 degrees and less than 90 degrees. In this embodiment, the angle (θ) is 45 degrees. The tail fin 111 has a rudder connecting edge 112 that extends along the pivot axis (Y). The rudder 10 has a pivot connection edge 11 that extends along the pivot axis (Y) and that is connected pivotally to the rudder connecting edge 112. The rudder 10 further has a pair of opposite rudder surfaces 12.

In this embodiment, the operating unit 20 includes a pair of cable connectors 21 (only one is visible) mounted respectively on the rudder surfaces 12 adjacent to the pivot connection edge 11, a pair of cable guides 22 (only one is visible) mounted on the tail boom 110, and a pair of control cables 23 (only one is visible) each of which is guided by a respective one of the cable guides 22 to extend parallel to the tail axis (X) and each of which is connected at one end to a respective one of the cable connectors 21. The other end of each of the control cables 23 extends into a cabin of the twin-rotor helicopter 100. Preferably, each of the rudder surfaces 12 is divided by the tail axis (X) into upper and lower sections. Each of the cable connectors 21 is mounted on the lower section of the respective one of the rudder surfaces 12. It is noted that the cable connectors 21, the cable guides 22 and the control cables 23 are symmetrically disposed with respect to the helicopter tail assembly.

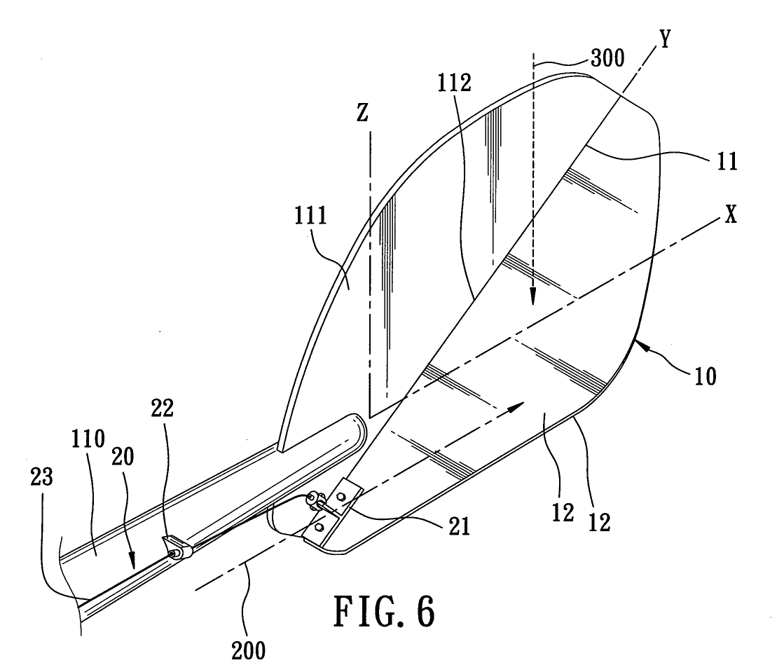

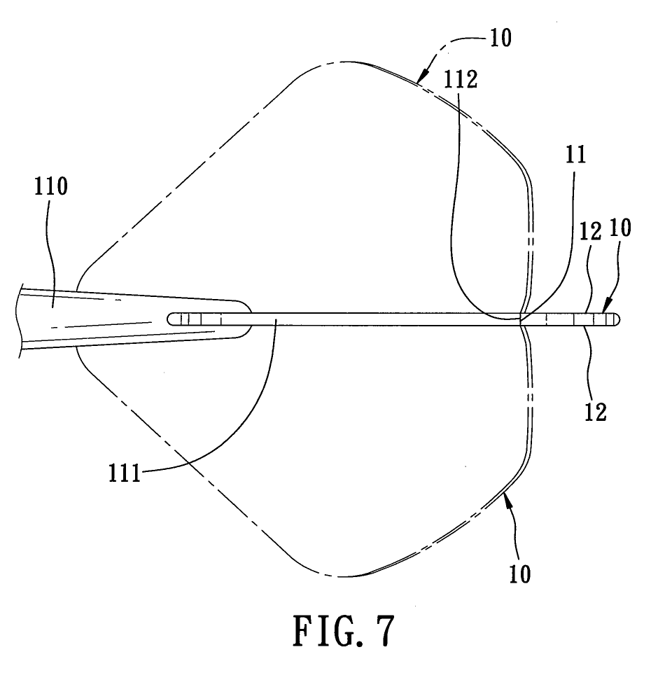

Referring to FIGS. 6 and 7, when the twin-rotor helicopter 100 flies forward, it is only required to operate the control cables 23 to pivot the rudder 10 in a desired direction so that an air stream 200 that flows rearwards (i.e., parallel to the tail axis (X)) is able to exert forces on the rudder surfaces 12 of the rudder 10 for yaw control. For instance, the rudder 10 is pivoted to the left when the twin-rotor helicopter 100 is to make a left turn while flying forward.

Likewise, when the twin-rotor helicopter 100 hovers, it is only required to operate the control cables 23 to pivot the rudder 10 in a desired direction so that an air stream 300 that flows downwards (i.e., parallel to a vertical axis (Z) that is transverse to the tail axis (X)) is able to exert forces on the rudder surfaces 12 of the rudder 10 for yaw control. For instance, the rudder 10 is pivoted to the left when the twin-rotor helicopter 100 is to make a left turn while hovering.

In sum, since the rudder 10 of the helicopter tail assembly of this invention is pivotable about the pivot axis (Y), which forms an angle (θ) with respect to the tail axis (X), the rudder surfaces 12 of the rudder 10 can be disposed to be not parallel to the tail axis (X) and the vertical axis (Z) when the rudder 10 is pivoted relative to the tail fin 111. As a result, the rearward air stream 200 can exert forces on the rudder surfaces 12 for yaw control when the twin-rotor helicopter 100 flies forward, and the downward air stream 300 can also exert forces on the rudder surfaces 12 for yaw control when the twin-rotor helicopter 100 hovers. Since the same rudder 10 can be used for yaw control when the twin-rotor helicopter 100 flies forward and when the twin-rotor helicopter 100 hovers, manufacturing costs can be lowered, the helicopter weight can be reduced, and yaw control is relatively easy to conduct.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A helicopter tail assembly comprising:
tail boom that extends along a tail axis;
tail fin mounted on one end of said tail boom; and
a rudder mounted on said tail fin and pivotable relative to said tail fin about a pivot axis that is inclined with respect to the tail axis at an angle greater than 0 degrees and less than 90 degrees.

2. The helicopter tail assembly as claimed in claim 1, wherein the angle is 45 degrees.

3. The helicopter tail assembly as claimed in claim 1, wherein said tail fin has a rudder connecting edge that extends along the pivot axis, and said rudder has a pivot connection edge that extends along the pivot axis and that is connected pivotally to said rudder connecting edge.

4. The helicopter tail assembly as claimed in claim 3, wherein said rudder further has a pair of opposite rudder surfaces, said helicopter tail assembly further comprising an operating unit that includes
a pair of cable connectors mounted respectively on said rudder surfaces adjacent to said pivot connection edge,
a pair of cable guides mounted on said tail boom, and
a pair of control cables each of which is guided by a respective one of said cable guides to extend parallel to the tail axis and each of which is connected at one end to a respective one of said cable connectors.

5. The helicopter tail assembly as claimed in claim 4, wherein each of said rudder surfaces is divided by the tail axis into upper and lower sections, each of said cable connectors being mounted on said lower section of the respective one of said rudder surfaces.
